(19) United States
(12) Patent Application Publication
(10) Pub. No.: US 2015/0310111 A1
(43) Pub. Date: Oct. 29, 2015

(54) SOURCE SEARCH ENGINE

(71) Applicant: Jorn LYSEGGEN, Mountain View, CA (US)

(72) Inventor: Jorn LYSEGGEN, Mountain View, CA (US)

(21) Appl. No.: 14/794,610

(22) Filed: Jul. 8, 2015

Related U.S. Application Data
(63) Continuation of application No. 11/750,704, filed on May 18, 2007, now abandoned.
(60) Provisional application No. 60/747,735, filed on May 19, 2006.

(51) Int. Cl. G06F 17/30

(52) U.S. Cl. CPC G06F 17/30864; G06F 17/30011; G06F 17/3053

(57) ABSTRACT

A method including receiving at least one search term (e.g. HIV) from an interface (e.g. a web browser on a personal computer). The method may search a network for documents (e.g. web pages) that include at least a portion of the search term. The method may determine the source (e.g. news outlets such as National Geographic or the National Enquirer) and sort the documents based on the source of the documents. A search engine may implement a method that uses the source to qualify (e.g. sort) search results based on the source of the documents.

Priority is claimed to U.S. Provisional Patent Application No. 60/747,735 (filed in the U.S. Patent and Trademark Office on May 19, 2006), which is herein incorporated by reference in entirety.

### BACKGROUND

With the evolution of computers, information networks, and the Internet, a large number of documents have become assessable to users. For example, a user of the Internet can access web pages from a vast number of resources located all over the world. As the amount of documents and/or content has rapidly increased over time, there have been challenges for users to locate relevant documents on topics that they are interested in.

Accordingly, along with that advent of the Internet and other networks (e.g. intranet networks), search engines have been developed. Search engines have allowed users to enter search terms and from these search terms are able to receive references (e.g. internet links) to documents. These references may be in the form of internet links that direct the user's web browser through the internet to download a document of interest (e.g. a web page).

However, there are inefficiencies in many search engines, which can result in a search engine being ineffective. For instance, when a user enters a search term (e.g. “HIV”), a search engine may produce many pages that relate to the subject of the search term. However, since there may be an indigestible amount of documents associated with the search term, a search engine may attempt to rank the relevance of the found documents in order to provide the user with access to documents that may be most interesting to the user. Unfortunately, some search engines may use processes (e.g. algorithms) that do not necessarily provide users with the most credible and relevant information. Accordingly, although some search engines may assist users in locating web pages, these search engines may still not be effective in providing and helping users locate documents or information that would be most useful to them. For example, if a user inputs a search term “HIV” into a search engine, the amount of results may be overwhelming and the relevancy of the results initially visible to the user may be quite limited.

Accordingly, one limitation of many search engines is the way that they rank the relevancy of documents (i.e. the order of which they appear from search engine results). Ranking of documents produced from a search engine search may appear random. Relevancy may be based on the amount of users that link to that page, the amount of links associated with that page, or other empirical means. However, many search engines do not use substantive relevancy characteristics of documents accessible on a network that may lead to search engine results with reliable relevance ranking. For example, many search engines do not use the source (e.g. author) of the documents as a factor in ranking the relevancy of search engine results.

### SUMMARY

Embodiments relate to a method including receiving at least one search term (e.g. HIV) from an interface (e.g. a web browser on a personal computer). The method may search a network for documents (e.g. web pages) that include at least a portion of the search term. The method may determine the source (e.g. news outlets such as National Geographic or the National Enquirer) and sort the documents based on the source of the documents. Accordingly, in accordance with embodiments, a search engine may implement a method that uses the source to qualify (e.g. sort) search results based on the source of the documents. For example, articles relating to the topic of “HIV” published from the National Geographic (often regarded by many as a credible news source) would be given more relevance than articles published by the National Enquirer (often considered an unreliable news source).

By sorting documents based on the source, more relevant search results may be offered to a user. In embodiments, the graphical user interface with a search engine using sources to sort for relevancy, may result in more relevant search results that are useful to the end user. In embodiments, search results from a search engine may be enhanced by listing sources to a user. The sources may be indicated along with the search results, in accordance with embodiments. A user may select the sources to navigate the user to documents that are most relevant to them based on the source, in accordance with embodiments. Accordingly, using a source search engine, in accordance with embodiments, may allow a user to have more effective and efficient access to the growing and vast number of documents available over the internet.

### DRAWINGS

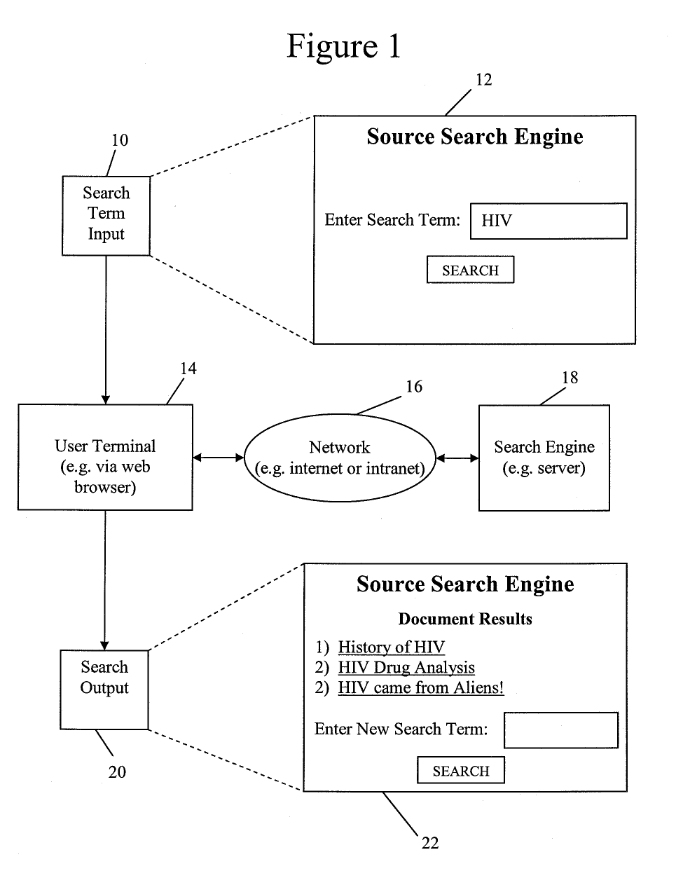

Example FIGS. 1-9 illustrate a source search engine interface including an example inputs and outputs, in accordance with embodiments.

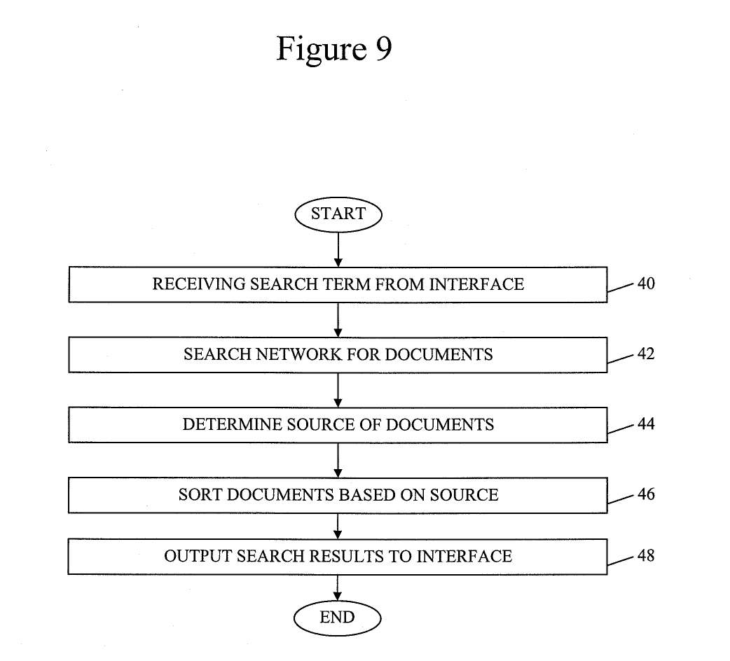

Example FIGS. 9-15 illustrate block diagram flow charts of processes that may be performed by a source search engine, in accordance with embodiments.

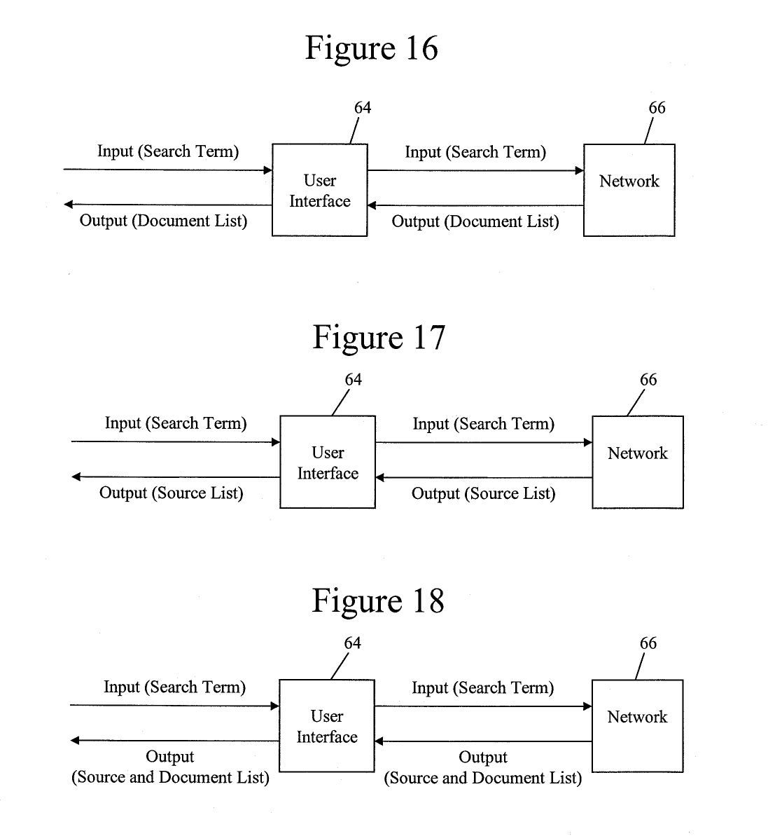

Example FIGS. 16-19 illustrate block diagrams of the interaction between a user interface and networks, in accordance with embodiments.

### DESCRIPTION

Example FIGS. 1-9 illustrate an example interface of a source search engine in accordance with embodiments. A search engine 18 may be included in computer hardware (e.g., a server, a personal computer, or other electronic device). A user terminal (e.g. a personal computer with a web browser, server with a graphical user interface, cell phone with keypad input, or other computing interface mechanism) may be connected to the search engine through a network 16 (e.g. the internet, an intranet network, or other computer network) or connected directly to the search engine 18. A search term input 10 may be input into a user terminal 14. Likewise, a search output 20 may be output from user terminal 14.

Example FIG. 1 illustrates a source search engine which outputs a list of documents in response to entering a search term. Window 12 is an example screen shot of a user interface at a user terminal 14 where a search term (e.g. “HIV”) is entered. After the search term is transmitted from a user terminal 14 to a search engine 18 through a network 16, search results (e.g. in the form of document results) may be output from user terminal 14 through search output 20. Window 22 illustrates an example screen shot of relevant documents that are output through a source search engine in response to the search term “HIV”. As illustrated in window 22, a document titled “History of HIV” appears first in a list of documents, followed by a document titled “HIV Drug Analysis”, and then followed by a document titled “HIV Came from Aliens!”. These example search results are ranked in relevancy, based on the source of the documents, in accordance with embodiments.

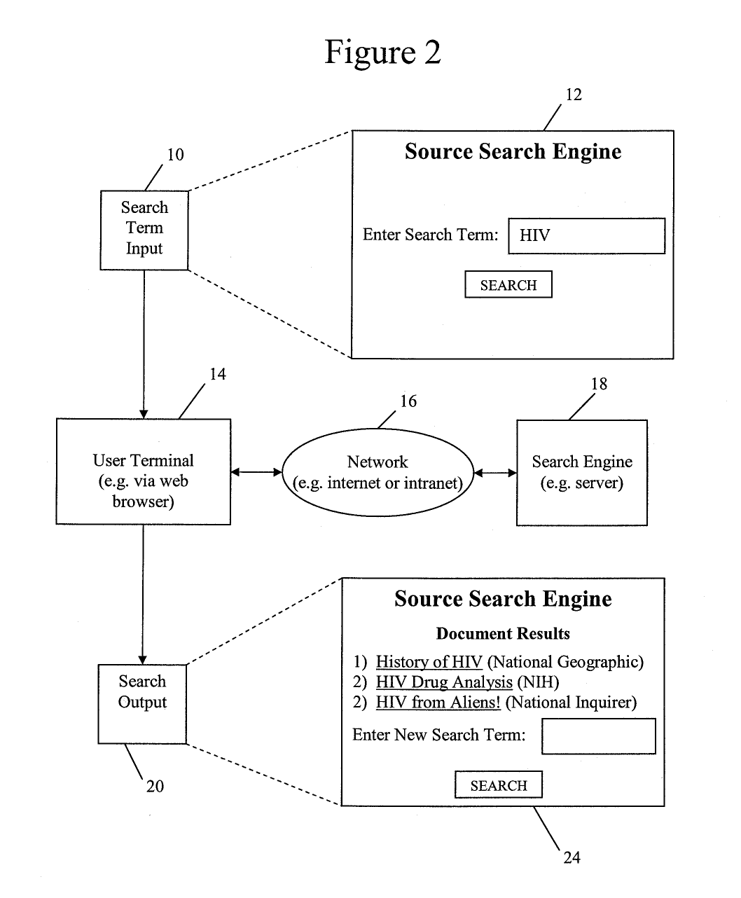

Example FIG. 2 is similar to embodiments illustrated in example FIG. 1. However, the search output 20 may have a window 24 that includes an indication of the source of the document along with the title of the document. For example, the document titled “History of HIV” is indicated as coming from the periodical National Geographic. Likewise, the document titled “HIV Drug Analysis” is indicated coming from the government source National Institute of Health (NIH). Further, the article titled “HIV Came from Aliens!” is indicated as originating from the periodical National Enquirer. An indication of the source of the documents, which may be used to rank the relevancy, may help the user select the most relevant document for their interest.

In embodiments illustrated in FIGS. 1 and 2, the title of the articles may include a link to those documents that may be accessed over a network.

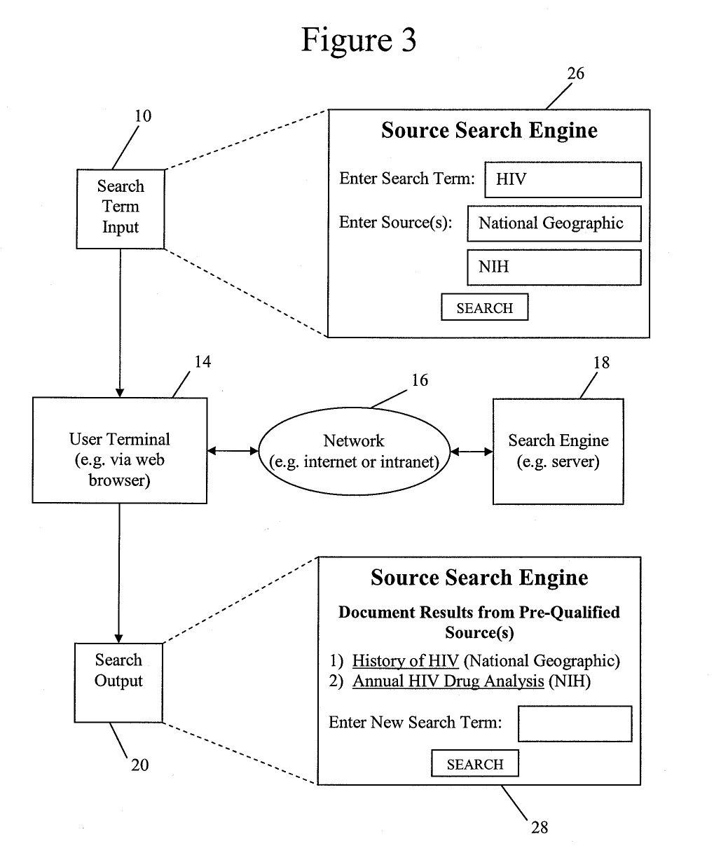

Example FIG. 3 illustrates embodiments similar to the embodiments illustrated in FIGS. 1 and 2, however the search term input 10 and search output 20 allow a user to indicate sources in the search term input 10. As illustrated in window 26, the source search engine allows input of the search term and sources that a user is interested in. In the example illustrated in window 26, the search term is “HIV” and the sources are indicated as “National Geographic” and “NIH”. As illustrated in example window 28, the documents listed are only from the sources National Geographic and NIH. In embodiments, the sources entered in window 26 may be considered pre-qualified sources in allowing a user to qualify what sources of information may be used to output the most relevant search results. In embodiments, search engine may substitute other sources that are considered equivalent to the input sources to output relevant search results.

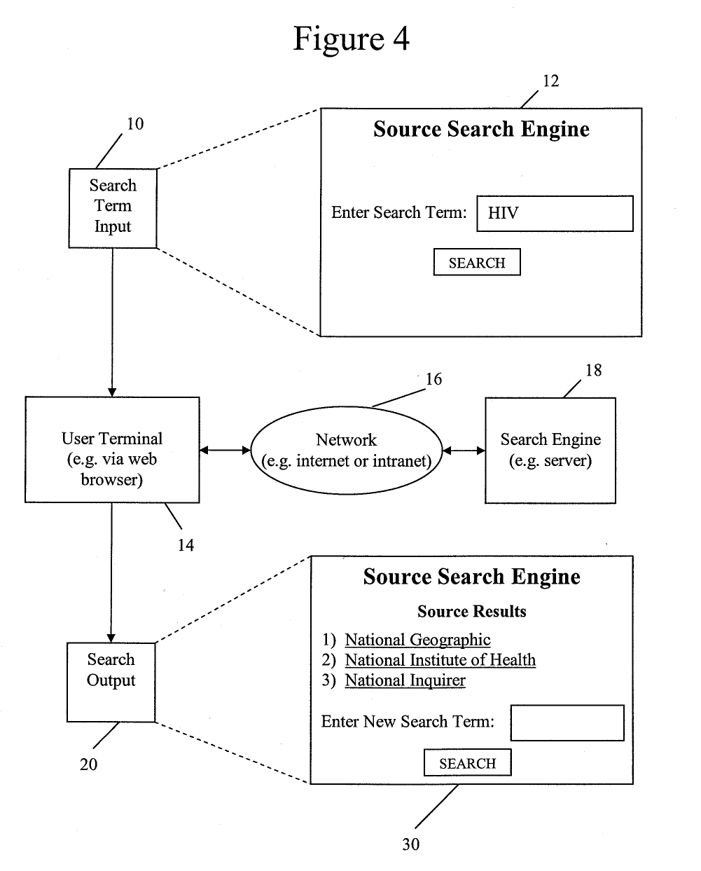

Example FIG. 4 illustrates embodiments similar to those in example FIGS. 1-3, however the search output 20 outputs source results instead of document results. As illustrated in example window 30, upon the input of the search term “HIV”, source results are output. In this example, the source results from the search term “HIV” are indicated as “National Geographic”, “National Institute of Health”, and “National Enquirer”. In embodiments, a user may select one of the sources to view a list of documents from that source. The sources may be ranked based on established credibility of the sources, the number of documents that are accessible by the sources, other substantive predetermined characteristics of the sources, other empirical data, and/or a combination of factors. In embodiments, since a user can select a source, the user may be able to access documents that are most relevant to their needs.

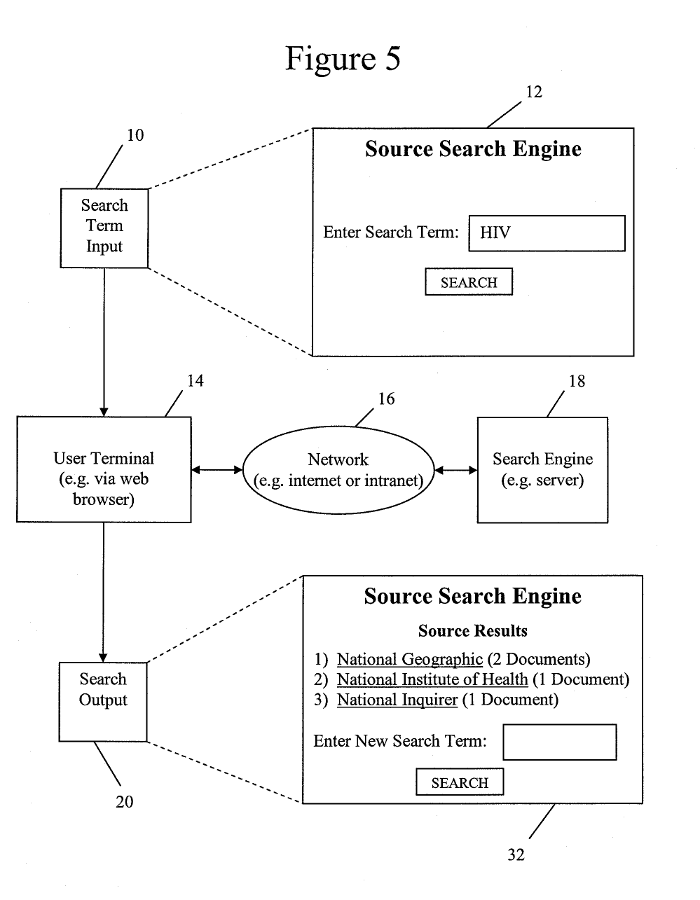

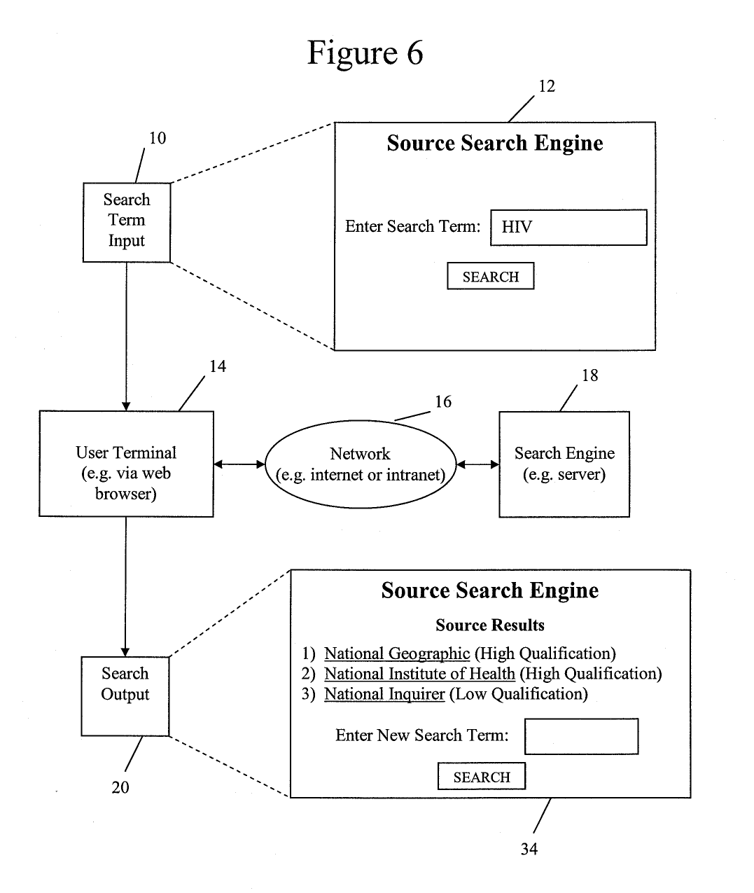

Example FIG. 5 illustrates embodiments similar to the embodiment illustrated in FIG. 4. As illustrated in window 32, the output of the source results may give other information about the documents associated with the source. For example, in the source results there may be indication of the number of documents that may be associated with that source. For example, in window 32, it is indicated that there are two documents associated with the periodical “National Geographic” resulting from the search term “HIV”. Likewise, it is indicated that there is one document from the source “National Institute of Health” and one document from the source “National Enquirer”. Likewise, in FIG. 6, the source results illustrated in window 34 may indicate the level of qualification of the source. For example, the source results in window 34 show National Geographic and National Institute of Health as having a “high qualification”, while National Enquirer is indicated as having a “low qualification”. The determination of something being qualified as high or low or on a scale, may be based on feedback from users, substantive determination that are used in a search engine algorithm, and/or empirical data. Example of empirical data could be the amount of access to articles from that source, patterns of access, time spend viewing documents, and/or other factors.

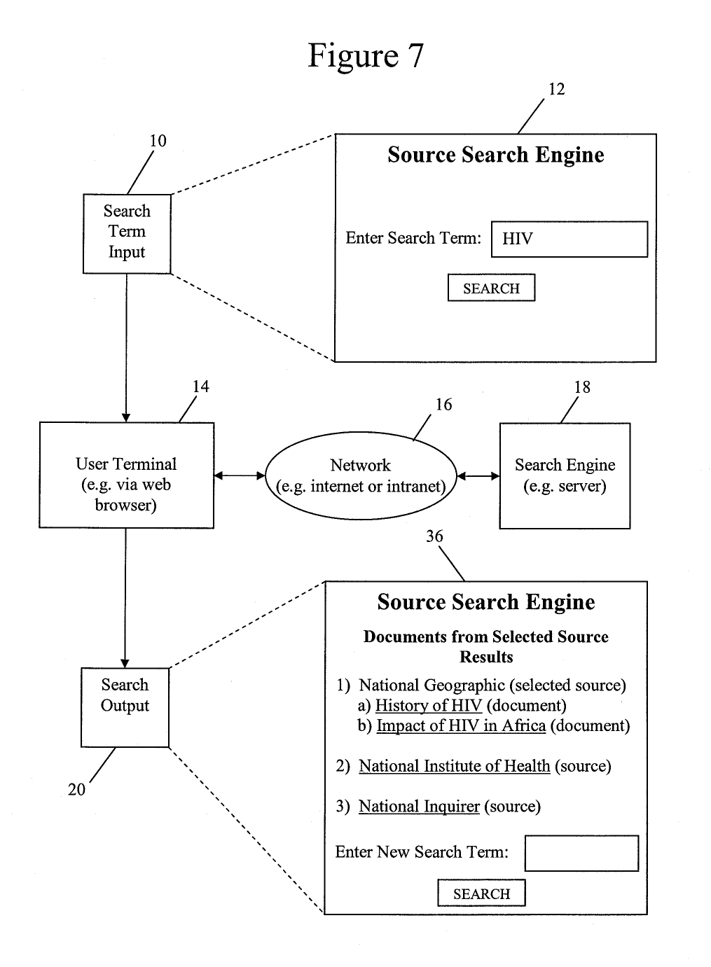

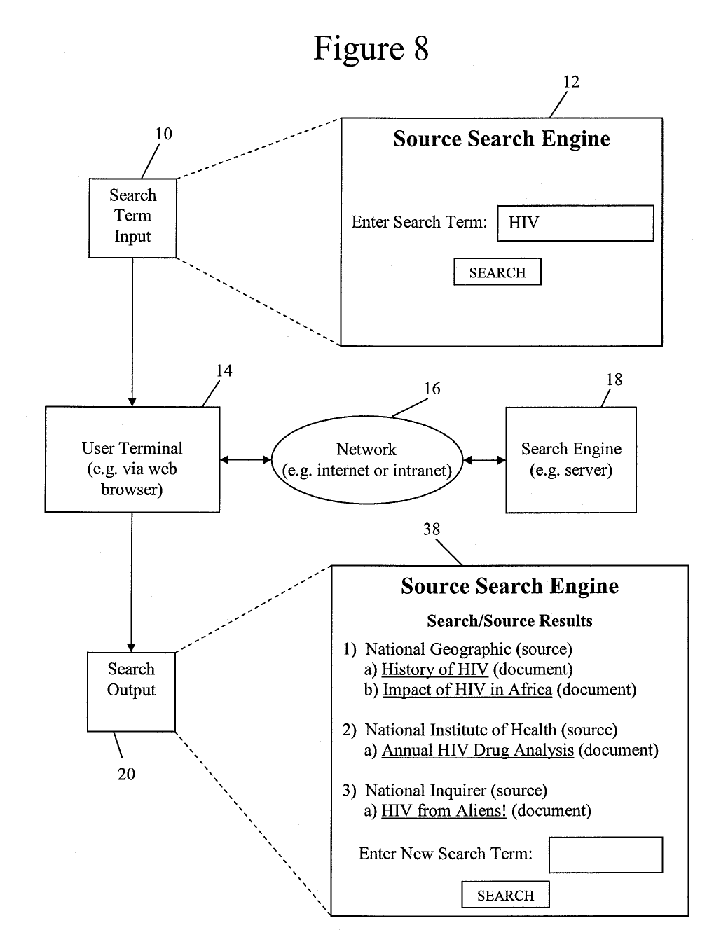

Example FIG. 7 illustrates embodiments similar to the embodiments illustrated in example FIGS. 1-6, where the search output includes an indication of both the source and documents associated with the source. As illustrated in window 36, a source may be selected to display a list of documents associated with the source. In this example, the source “National Geographic” is selected to display articles titled “History of HIV” and “Impact of HIV in Africa”. Although the source is “National Institute of Health” and “National Enquirer” may not be selected, they may still be visible as a source result. Similar embodiments illustrated in FIG. 7, embodiments illustrated in FIG. 8 may show all documents or selected documents or most qualified documents associated with source results.

Sources may include people who authored documents, people quoted in documents, entities (e.g. companies, associations, governmental bodies, or any other organization) which authored documents, entities that are quoted in documents, and/or any other person (and/or entity) associated with the search term. In embodiments, the sources may be ranked by an algorithm in the order of importance (e.g. frequency of association with documents, credibility of a media outlet publishing a document, credibility of the organization associated with a document, etc.).

Example FIGS. 9-15 illustrate algorithms that may be implemented in a search engine, in accordance with embodiments. One of ordinary skill in the art would appreciate that modifications of the algorithms may be done without departing from the spirit of embodiments. As illustrated in example FIG. 9, a search engine may receive search terms from an interface (block 40). A search engine may search a network for documents (block 42). A search engine may determine the source of the documents (block 44). The search engine may sort the documents based on the source (block 46). The search engine may output the search results to interface (block 48).

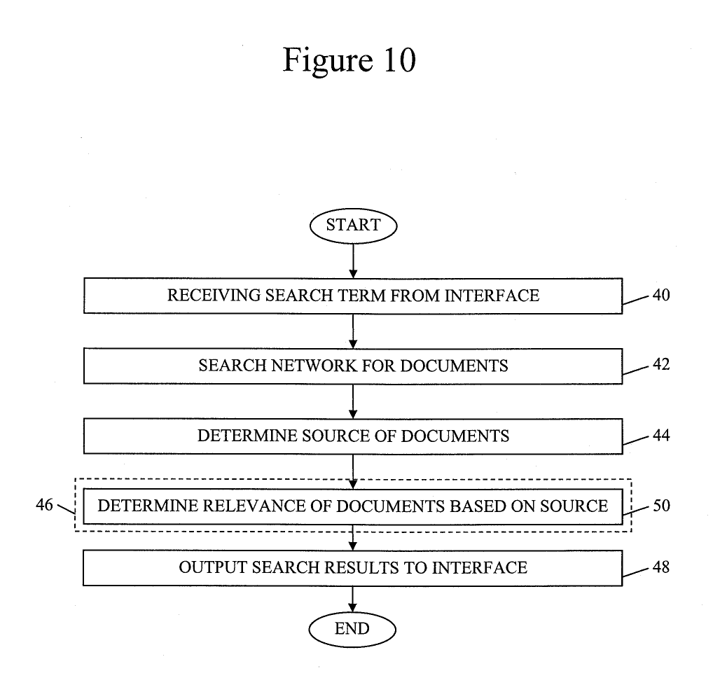

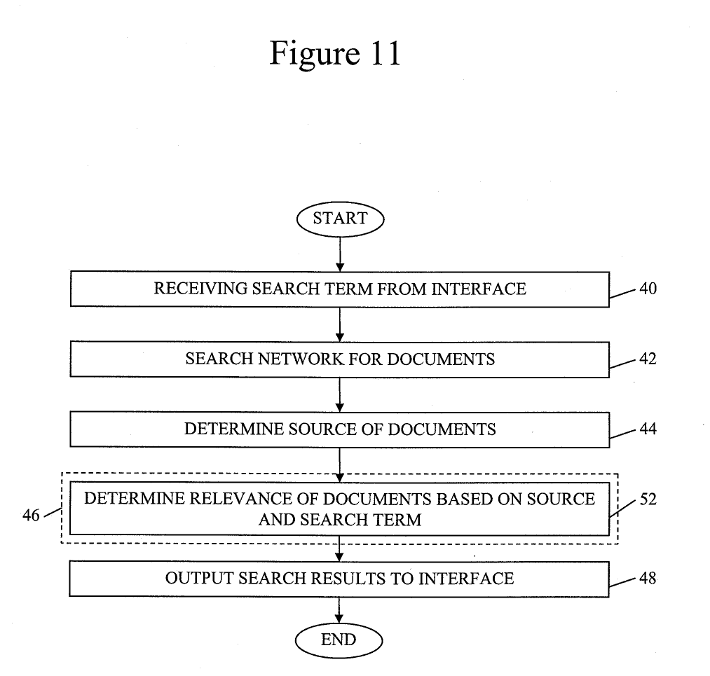

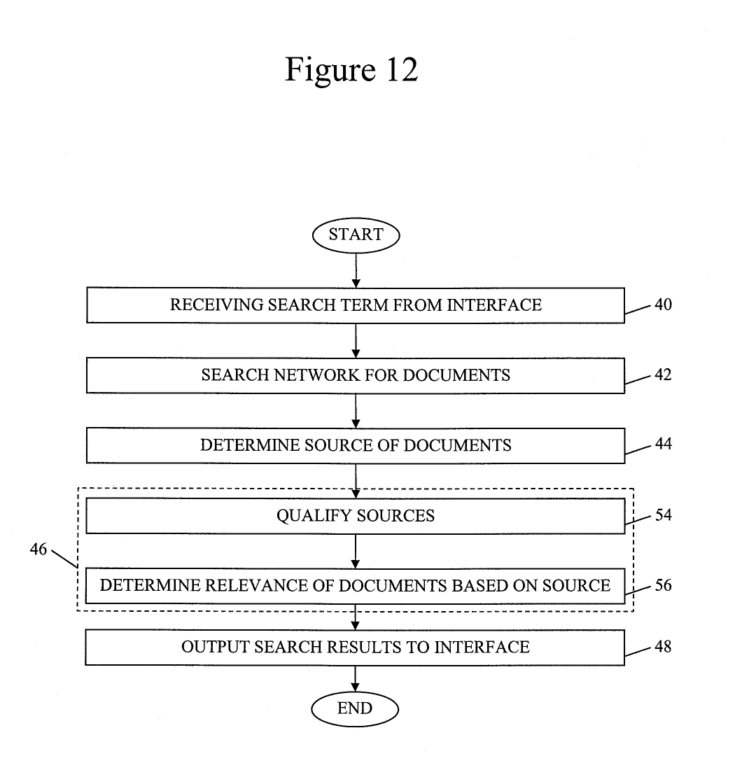

In embodiments illustrated in FIG. 10, the sorting of documents based on the source, may include determining the relevancy of documents based on the source (block 50). As illustrated in example FIG. 11, the sorting of documents based on the source may include determining the relevancy of documents based on the source and the search term (block 52). As illustrated in example FIG. 12, the sorting of documents based on the source may be include qualifying the sources (block 54) and/or determining the relevancy of documents based on the source (block 56), in accordance with embodiments.

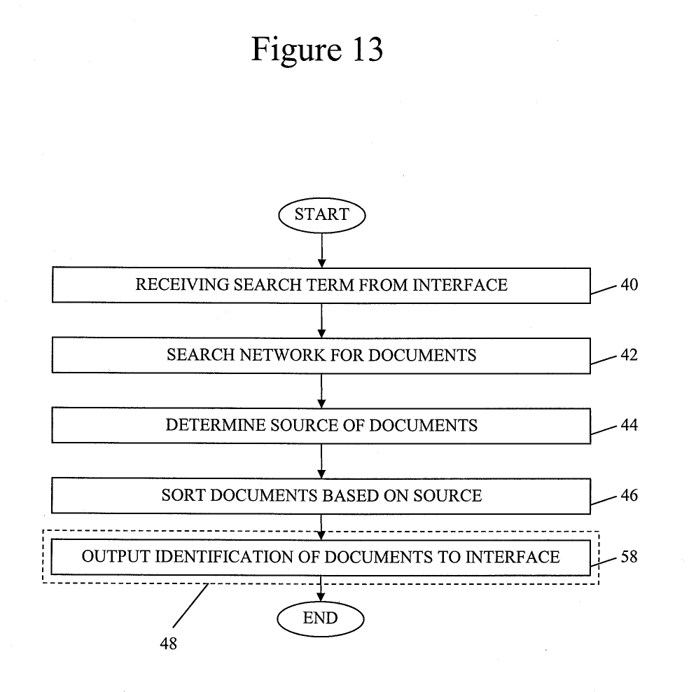

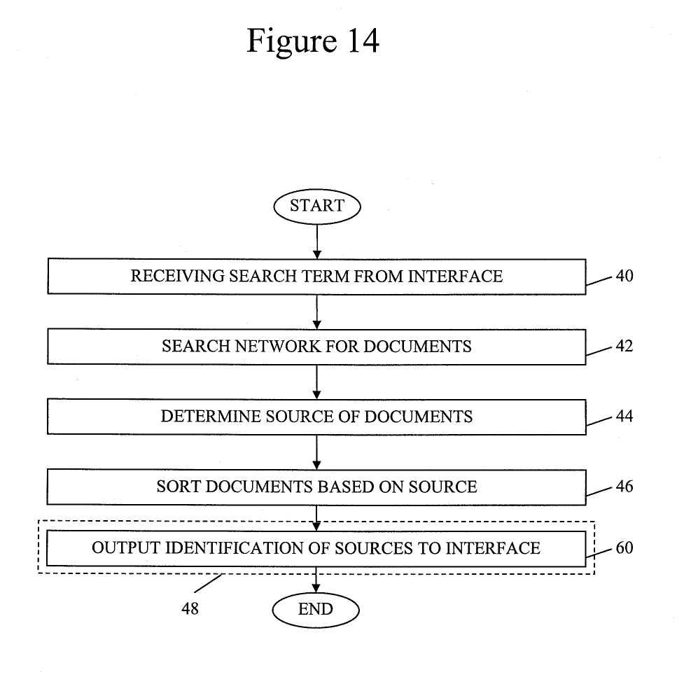

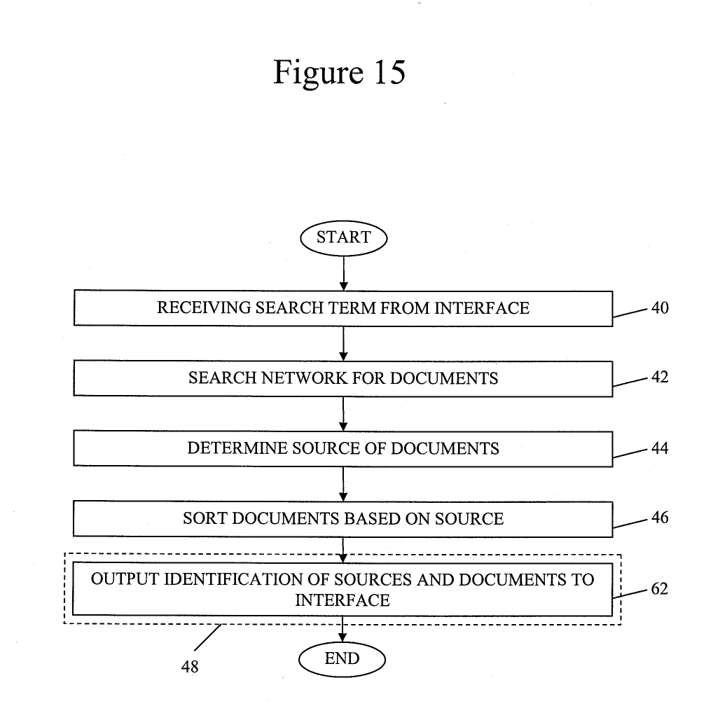

Embodiments illustrated in FIGS. 13-15, the outputting of search results to an interface may be accomplished in different ways. As illustrated in example FIG. 13, search results may be output to an interface by outputting identification of the documents to the interface (block 58), similar to example FIG. 1. As illustrated in example FIG. 14, the outputting of search results to an interface may include outputting identification of the sources to the interface (block 60), similar to example FIGS. 3-6. As illustrated in example FIG. 15, the outputting search results to an interface may include outputting identification of source and documents to an interface (block 62), similar to example FIGS. 7-8.

Example FIGS. 16-18 illustrate interaction between a user interface 64 and network 66, in accordance with embodiments. As illustrated in example FIG. 16, a search term may be input into a user interface 64 which is then communicated through a network 66. The network may interact with search engine to output a document list to user interface 64 which is displayed to a user. As illustrated in example FIG. 17, in accordance with embodiments, a search term may be input into a user interface 64. The user interface may communicate that search term through a network 66 to a search engine, thereby outputting a source list to the user interface 64 to be displayed to the user. As illustrated in example FIG. 18, a search term may be input into a user interface 64. The search term may be communicated from the user interface 64 to a network 66. The network 66 may include a search engine that outputs source and document lists to the user interface 64 to be displayed to the user.

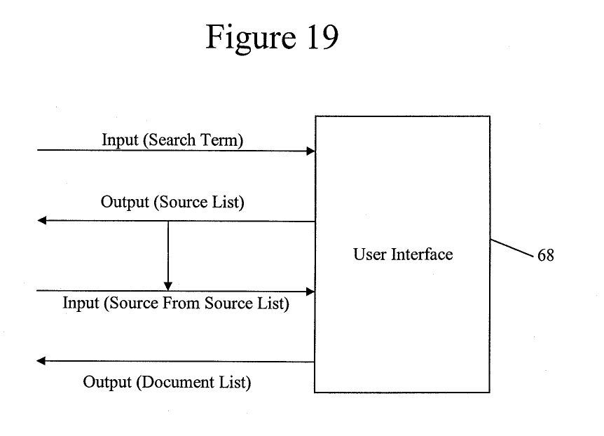

Example FIG. 19 illustrates a user's interaction with the user interface 68 in accordance with embodiments. As illustrated, a user may input a search term to the user interface 68. The user interface may output a source list in accordance with embodiments. The user may input (e.g. select) a source from the source list into the user interface 68 which causes the display of a document list. In embodiments, it may be unnecessary for the user to select a source from a source list. In embodiments, a source list includes a document list. One of ordinary skill in the art would appreciate various combinations of source lists and documents lists and search terms and sources selected by a user in order to receive the most relevant documents from a search engine.

Embodiments relate to methods that include receiving at least one search term from an interface. In embodiments, the interface may be an internet interface. In embodiments, the interface may be an intranet interface. In embodiments, the interface may be any other kind of computer interface or personal interface that allows the input of search terms. In embodiments, a search term may include words and/or the input of files. Input words may include terms to be searched, list of sources, or other relevant information.

Embodiments relate to a method that includes searching a network for documents that include at least a portion of a input search term. In embodiments, a network may be an internet network. In embodiments, a network may be an intranet network. In embodiments, a network may be any kind of computer network, including open networks and closed networks. In embodiments, the search engine may be a source search engine and/or other kinds of search engines. In embodiments, a network may be an information retrieval system designed to help find stored information on a computer system.

In embodiments, documents may include web pages. In embodiments, documents may include published articles. In embodiments, documents may include audio clips. In embodiments, documents may include video clips. In embodiments, documents may include physical documents. In embodiments, documents may include electronic documents. In embodiments, documents may include any other kind of content that is assessable or identifiable on a network.

Embodiments relate to a method including determining a source of documents. In embodiments, a source may be a person that authored a document. In embodiments, a source may be a person that published a document. In embodiments, a source may be a person quoted in a document. In embodiments, a source may be a person associated with the search term. In embodiments, a source may be an organization that authored a document. In embodiments, a source may be an organization that published a document. In embodiments, a source may be an organization that is quoted in the document. In embodiments, a source may be an organization associated with a search term.

Embodiments relate to a method that includes sorting documents based on the source of the documents. In embodiments, a method may include determining the relevance of documents based on the source of the document. In embodiments, determining the relevance of documents based on the source of documents, may be included in sorting documents based on the source of the documents. In embodiments, determining the relevancy of documents may be based on the source of the document. In embodiments, determining the relevance may be based on the match quality of the documents. In embodiments, determining the relevance of a document may be based on the source of the document and the match quality of the document.

In embodiments, determining the relevance of a document may include qualifying the source of the document. Qualifying the source of a document may be performed empirically (e.g. statistical analysis of documents and related documents). In embodiments, the qualification of documents may be based on a user input or search engine parameters. The user input may include pre-qualified sources that are of most interest to a user. In embodiments, a search engine may use equivalence to pre-qualified sources in order to find relevant documents. In embodiments, a user interface may display a list of documents in an order from determined most relevant to determined least relevant.

In embodiments, an interface may output identification of sources of documents in a manner based on the relative qualification of the source. In embodiments, sources that are more qualified may be listed before sources that are less qualified. In embodiments, documents may be grouped by the source.

In embodiments, documents may be output to a user interface as selectable sources. A user may select a source to allow the output of documents associated with that selected source.

In embodiments, qualifying a source may be based on the reputation of the source. In embodiments, reputation of the source may be based on the credibility of people that are authored documents of the source. In embodiments, reputation of the source may be based on credibility of people of published documents from the source. In embodiments, reputation may be based on the credibility of people quoted in documents from the source. In embodiments, reputation may be based on credibility of people associated with a search term in documents from the source. In embodiments, reputation of a source may be based on credibility of organizations of authored documents from a source. In embodiments, reputation of a source may be based credibility of organizations that publish documents from a source. In embodiments, reputation of a source may be based on credibility of organizations that are quoted in documents by a source. In embodiments, reputation of a source may be based on credibility of organizations associated with one search term in documents from a source. One of ordinary skill in the art would appreciate other ways of reputation of a source may be assigned.

In embodiments, qualifying a source of documents may be based on the relevant quantity of documents found during a search that are from the source. In embodiments, qualifying a source of documents may be based on the source being one of at least one preferred source. Embodiments of the preferred source may be assigned by algorithm into a search engine by administrators or determined by a specific user of a search engine.

The foregoing embodiments (e.g. source search engine) and advantages are merely examples and are not to be construed as limiting the appended claims. The above teachings can be applied to other apparatuses and methods, as would be appreciated by one of ordinary skill in the art. Many alternatives, modifications, and variations will be apparent to those skilled in the art.

1.-20. (canceled)

21. An electronic device comprising:
a processor;
a non-transitory storage medium coupled to the processor and configured to store instructions for execution by the processor to cause the electronic device to:
receive at least one search term from an interface;
search a network for documents that comprise at least a portion of the at least one search term;
determine a source of resulting documents of the search;
determine the relevance of the resulting documents based at least on the source of the resulting documents comprising qualifying the source of the resulting documents based at least on:
reputation of the source; and
equivalence to at least one pre-qualified source input by a user;
sort the resulting documents based at least on the qualifying the source of the resulting documents.

22. The electronic device of claim 21, wherein qualifying the source of the resulting documents comprises one or more of:
comparing the reputation of the source of each resulting document to others of the resulting documents;
comparing a number of documents that are accessible from the source of each resulting document to the source of others of the resulting documents; or comparing the equivalence of each source of the resulting documents to at least one pre-qualified source input by a user.

23. The electronic device of claim 21, wherein qualifying the source of the resulting documents comprising comparing the established reputation of the source of each resulting document to other resulting documents.

24. The electronic device of claim 21, wherein qualifying the source of the resulting documents comprising comparing the equivalence to at least one pre-qualified source input by a user of each resulting document to other resulting documents.

25. The electronic device of claim 21, wherein:
the interface is at least one of an internet interface or an intranet interface; and
the network is at least one of an internet network or an intranet network.

26. The electronic device of claim 21, wherein the documents include at least one of:
web pages;
published articles;
audio clips;
video clips; or
electronic documents.

27. The electronic device of claim 21, wherein the source is at least one of:
one or more person that authored documents;
one or more person that published documents;
one or more person quoted in documents;
one or more person associated with the at least one search term;
one or more organization that authored documents;
one or more organization that published documents;
one or more organization that are quoted in documents; or
one or more organization associated with the at least one search term.

28. The electronic device of claim 21, wherein the determining the relevance of the documents is based on the source of the documents and the match quality of the documents to the at least one search term.

29. The electronic device of claim 21, comprising outputting to the interface identification of the documents in a manner based on the relative relevance of the documents.

30. The electronic device of claim 29, wherein the manner based on the relative relevance of the documents comprises listing the documents in order of most relevant to least relevant.

31. The electronic device of claim 21, comprising outputting to the interface identification of the source of the documents in a manner based on the relative qualification of the source.

32. The electronic device of claim 31, wherein the manner based on the relative qualification of the source comprises listing the sources in order of most qualified to least qualified.

33. The electronic device of claim 31, comprising outputting to the interface identification of the documents grouped by the source of the documents in a manner based on the relative qualification of the source.

34. The electronic device of claim 31, wherein the outputting comprises:
outputting at least one source of the documents;
receiving a selection of at least one of the at least one source; and
outputting at least one of the documents associated with the at least one selected source.

35. The electronic device of claim 34, wherein the outputting the at least one source of the documents comprises outputting qualification characteristics of the at least one source.

36. The electronic device of claim 21, wherein the reputation of the source is based on at least one of:
credibility of one or more person that authored documents;
credibility of one or more person that published documents;
credibility of one or more person quoted in documents;
credibility of one or more person associated with the at least one search term;
credibility of one or more organization that authored documents;
credibility of one or more organization that published documents;
credibility of one or more organization that are quoted in documents; or
credibility of one or more organization associated with the at least one search term.

37. The electronic device of claim 21, wherein the qualifying the source of the documents is based on relative quantity of documents found during the search that are from the source.

38. The electronic device of claim 21, wherein:
the at least one search term includes at least one preferred source; and
the qualifying the source of the documents is based on the source being one of the at least one preferred source.

39. A computer implemented method comprising:
receiving at least one search term from an interface;
searching a network for documents that comprise at least a portion of the at least one search term;
determining a source of resulting documents of the search;
determining the relevance of the resulting documents based at least on the source of the resulting documents comprising qualifying the source of the resulting documents based at least on;
reputation of the source; and
equivalence to at least one pre-qualified source input by a user;
sorting the resulting documents based at least on the qualifying the source of the resulting documents.

40. A non-transitory medium configured to store instructions to cause an electronic device to perform functions, the instructions comprising:
receiving at least one search term from an interface;
searching a network for documents that comprise at least a portion of the at least one search term;
determining a source of resulting documents of the search;
determining the relevance of the resulting documents based at least on the source of the resulting documents comprising qualifying the source of the resulting documents based at least on;
reputation of the source; and
equivalence to at least one pre-qualified source input by a user;
sorting the resulting documents based at least on the qualifying the source of the resulting documents;
wherein qualifying the source of the resulting documents comprises comparing the established reputation of the source and the equivalence to at least one pre-qualified source input of each resulting document to the established reputation of the source and the equivalence to at least one pre-qualified source input of each other resulting document.
